(19) United States
(12) Patent Application Publication
(10) Pub. No.: US 2026/0297704 A1
(43) Pub. Date: Oct. 1, 2026

(54) METHOD FOR ANTIMONY RECOVERY AND SYNERGISTIC FLUORINE FIXATION FROM LOW-GRADE COMPLEX ANTIMONY OXIDE RESOURCES

(71) Applicant: Kunming University of Science and Technology, Kunming (CN)

(72) Inventors: Hua Wang, Kunming (CN); Yong Yu, Kunming (CN); Xiang Liu, Kunming (CN); Jianhang Hu, Kunming (CN); Cheng Tan, Kunming (CN); Luojian Jiwu, Kunming (CN); Peng Zhu, Kunming (CN)

(21) Appl. No.: 19/640,600

(22) Filed: Apr. 7, 2026

(30) Foreign Application Priority Data
May 22, 2025 (CN) 202510667391.0

(51) Int. Cl. C22B 30/02; C22B 1/24; C22B 5/10

(52) U.S. Cl. CPC C22B 30/02; C22B 1/2406; C22B 5/10

(57) ABSTRACT

Disclosed is a method for antimony recovery and synergistic fluorine fixation from low-grade complex antimony oxide resources. The disclosure relates to the technical field of efficient recovery and reuse of metal mineral resources. The present disclosure includes (1) crushing low-grade complex antimony oxide resources, mixing with carbonaceous reducing agent A uniformly, and making the mixture I into pellets; (2) drying the pellets obtained in step (1), mixing the dried pellets with carbonaceous reducing agent B, roasting mixture II, collecting the flue gas generated by roasting, and cooling the flue gas to obtain high-quality antimony-containing dust. With the method, efficient and high-quality recovery of antimony from low-grade complex antimony oxide resources through a green and low-cost method is realized, solving the industry's bottleneck problem of efficient utilization of low-grade complex antimony oxide resources.

### CROSS-REFERENCE TO RELATED APPLICATIONS

This application claims to the benefit of priority from Chinese Application No. 202510667391.0 with a filing date of May 22, 2025. The content of the aforementioned applications, including any intervening amendments thereto, are incorporated herein by reference.

### TECHNICAL FIELD

The present disclosure relates to the technical field of efficient recovery and reuse of metal mineral resources, in particular to a method for antimony recovery and synergistic fluorine fixation from low-grade complex antimony oxide resources.

### BACKGROUND

Antimony is an important strategic resource in China and an indispensable key rare metal. China has relatively abundant antimony resources, with antimony production accounting for about 48% of the world's total in 2023 (global antimony production is 83000 tons). In recent years, China's antimony mines have a high degree of development and utilization, and the consumption of resources is large. Most large and super-large mines have been mined for more than 50 years, and 63% of antimony resources with economic value have been consumed.

China is the world's largest producer of antimony, with reserves ranking first in the world. The smelting technology is in a leading position in the antimony industry, the technological innovation represented by low-carbon collaborative smelting and oxygen-enriched strengthening process has significantly improved the resource utilization rate and environmental protection level. Besides, by relying on the complete industrial chain and technical barriers, the international competitive advantage is consolidated. However, the resources of traditional stibnite (Sb₂S₃) mining areas in Hunan and Guizhou have been exhausted, and the development of emerging mining areas in Xizang and Yunnan is lagging behind. The static reserve-to-production ratio of antimony ores in China is only six years, far below the global average level of 24 years. The efficient utilization technology of low-grade complex antimony oxide resources has become a key breakthrough direction.

At present, research on the utilization of antimony oxide resources has been conducted both domestically and internationally, mainly using processes such as manual selection, gravity separation, flotation, sulfide flotation, combined gravity separation and flotation, and roasting. The disseminated grain size of useful minerals in antimony oxide resources is fine and the symbiotic relationship with other minerals is complex, so its high-efficiency ore beneficiation is one of the difficult problems in the world. In low-grade complex antimony oxide resources, the antimony content is low and the phase is complex, and the impurity elements fluorine and iron are high. At present, metal antimony is usually obtained through antimony oxide reduction smelting. However, due to the low antimony content and complex antimony phase in low-grade complex antimony oxide resources, the high-temperature process of reduction smelting is prone to generate antimony alloys, resulting in low antimony recovery rates. To maintain a high antimony recovery rate in the reduction smelting process, complex additives need to be added, leading to increased reduction smelting costs and poor process economy. At the same time, due to the presence of fluorine impurities in low-grade complex antimony oxide resources, fluorine is prone to volatilization in the melt pool during smelting process, resulting in secondary pollution.

Therefore, it is necessary to provide a method for antimony recovery and synergistic fluorine fixation by roasting low-grade complex antimony oxide resources, so as to improve the recovery rate of antimony in low-grade complex antimony oxide resources, reduce the impurity content in recovered antimony, improve the purity of recovered antimony, and obtain high-quality antimony resources.

### SUMMARY

In order to overcome the problems in the background technology, the present disclosure adopts a roasting method to recover low-grade complex antimony oxide resources, while achieving fluorine fixation. On the one hand, it effectively improves the antimony recovery rate, and on the other hand, it fixes fluorine impurities in the roasting slag, without entering the flue gas, thereby reducing the impurity content in the final recovered material, improving the purity of the recovered antimony resources, increasing the quality of the recovered antimony resources, and reducing secondary pollution.

In order to achieve the above objectives, the present disclosure is realized by the following technical solution:

The method includes the following steps:
(1) crushing the low-grade complex antimony oxide resources, mixing with carbonaceous reducing agent A uniformly, and making mixture I into pellets. The mixture I can be made into pellets through conventional granulation techniques.
(2) drying the pellets obtained in step (1), mixing the dried pellets with carbonaceous reducing agent B uniformly, roasting mixture II, collecting flue gas generated by roasting, and cooling the flue gas to obtain high-quality antimony-containing dust, so as to realize efficient and high-quality antimony recovery.

Preferably, the low-grade complex antimony oxide resources include at least one of senarmontite, valentinite, kermesite, stibiconite, cervantite, sarabauite, romeite, and chemically dissolved antimony, mass fraction of antimony in the low-grade complex antimony oxide resource is 1.0-10%;

Preferably, in step (1), the particle size of the low-grade complex antimony oxide resources crushed is 50-300 μm.

Preferably, the low-grade complex antimony oxide resource further includes antimony smelting waste, and the mass fraction of the antimony smelting waste in the low-grade complex antimony oxide resource is not more than 15%.

Preferably, the carbon dioxide reactivity of the carbonaceous reducing agent A is higher than that of anthracite in the temperature range of 600-900° C. For example, the properties of lignite, bituminous coal, and semi coke all meet the aforementioned requirements. The carbonaceous reducing agent A can be a single substance or a mixture, such as a mixture of lignite and bituminous coal, a mixture of bituminous coal and semi coke, a mixture of various substances such as lignite, bituminous coal, semi coke. When the carbonaceous reducing agent A is a mixture, the mass ratio of the substances can be arbitrary.

Preferably, in step (1), the mass ratio of the low-grade complex antimony oxide resources and the carbonaceous reducing agent A is 100:(1-8).

Preferably, in step (2), a roasting heating rate is 5-30° C./min.

Preferably, in step (2), the roasting temperature is 600-950° C. and the holding time is 20-220 minutes.

Preferably, in step (2), the ash mass fraction of the carbonaceous reducing agent B is less than 18%, and the particle size of the carbonaceous reducing agent B is 74 μm-3 cm. For example, substances such as bituminous coal, petroleum coke, and coke have ash mass fractions that meet the requirements. Similarly, the carbonaceous reducing agent B can be a single substance or a mixture, such as a mixture of bituminous coal and petroleum coke, a mixture of bituminous coal and coke, or a mixture of bituminous coal, petroleum coke, and coke. When the carbonaceous reducing agent B is a mixture, the mass ratio of the substances can be arbitrary.

Preferably, in step (2), the mass ratio of the pellets and the carbonaceous reducing agent B is 100:(5-30).

In the process of recovering antimony resources according to the present disclosure, the complex antimony phases include senarmontite, valentinite (Sb₂O₃), kermesite (Sb₂S₂O), sarabauite (CaSb₁₀O₁₀S₆), cervantite (Sb₂O₄), stibiconite (Sb₂O₄·H₂O), romeite ((Ca,Fe,Mn,Na)₂(Sb,Ti)₂O₆(O,OH,F)), etc., involving the following chemical equations:

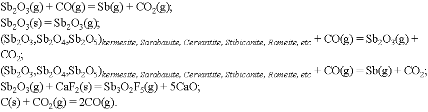

The advantageous effects of the present disclosure are as following:
1. Through coupling key parameters, such as temperature, physical and chemical properties of carbonaceous reducing agents, with addition methods, the selective conversion of complex antimony phases to Sb(g) is regulated, and the formation of Sb₂O₃ (g) and Sb alloy is inhibited, thereby hindering the formation of Sb₃O₂F₅ (g). This achieves efficient and high-quality recovery of antimony from low-grade complex antimony oxide resources, with the antimony recovery rates exceeding 95%, the antimony enrichment rate in flue dust exceeding 10%, and the fluorine-fixing ratio exceeding 95%.
2. A small amount of carbonaceous reducing agent A with excellent low-temperature reactivity is granulated with low-grade complex antimony oxide resources to ensure that the reducing atmosphere inside the pellets promotes the formation of Sb(g) in the low-temperature range, and the low-temperature and the Sb(g) formation inhibit fluorine volatilization. The introduction of carbonaceous reductant B with coarse particle and low ash content avoids the secondary oxidation in the pellet during the roasting process, while the low ash content ensures the efficient enrichment of antimony in the flue dust.
3. In the process of recovering antimony, only carbonaceous reducing agent A and carbonaceous reducing agent B need to be used, without the need to add other chemical reagents, and almost no liquid substances are involved in the recovery process, which can effectively reduce the production of waste liquid and other pollutants. At the same time, fluorine is fixed to reduce the probability of secondary pollution caused by fluorine volatilization and improve the environmental friendliness of the recovery process.
4. The recovery process is simple, with less additive demand and lower cost. The high-efficiency and high-quality recovery of antimony in the low-grade complex antimony oxide resources that are difficult to treat can be realized in a green, environmentally-friendly and low-cost way, solving the industry's bottleneck problem of efficient utilization of low-grade complex antimony oxide resources.

### BRIEF DESCRIPTION OF THE DRAWINGS

FIG. 1 is a process flow diagram of the method of the present disclosure.

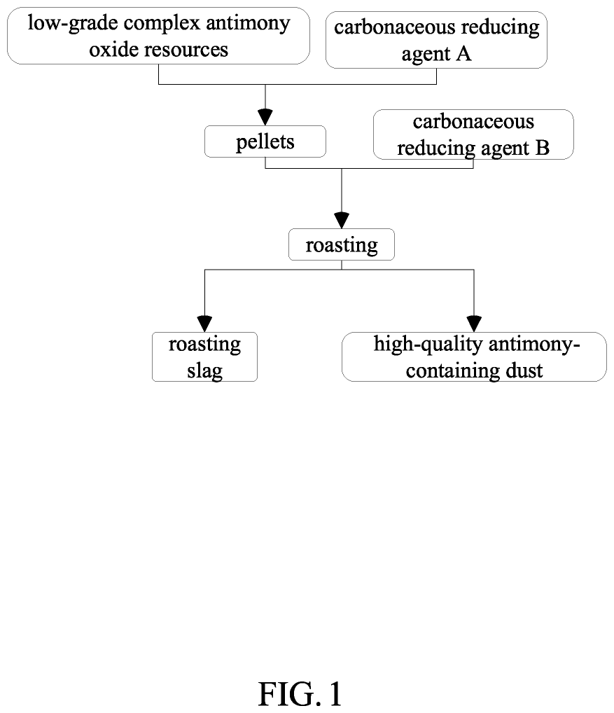

### DETAILED DESCRIPTION OF THE EMBODIMENTS

The present disclosure will be further described in detail with reference to the accompanying drawings and specific embodiments, but the scope of the present disclosure is not limited to the described content.

### Embodiment 1

In the embodiment, antimony from low-grade complex antimony oxide resources is recovered through the following methods:
(1) Mixing and crushing low-grade oxidized complex antimony ore (single senarmontite) with antimony smelting waste to 200 μm (the addition ratio of antimony smelting waste is 15%) to obtain low-grade complex antimony oxide resources (In low-grade complex oxidic antimony resources, the antimony content is 5.35%, the fluorine content is 2.14%, and the iron content is 10.71%), then mixing the low-grade complex antimony oxide resources with semi coke evenly to form pellets (mixture I), with a ratio of the antimony oxide resources to semi coke is 100:8. The mixture I can be made into a pellet by using an existing pelletizer.
(2) Drying the pellets and mixing with bituminous coal (ash content: 10%) to form mixture II (the ratio of pellets to bituminous coal is 100:5), then heating the mixture II to 800° C. by natural gas heating at a heating rate of 5° C./min and keeping the temperature for 40 minutes, and then cooling the flue gas to obtain high-quality antimony dust.

The components of roasting slag and flue dust were detected, and the results showed that the antimony content in the roasting slag was only 0.10%, the fluorine-fixing ratio was more than 97%, and the antimony enrichment rate in the flue dust was greater than 12, which proves that the method can realize high-quality and efficient recovery of antimony resources and reuse of smelting waste.

### Embodiment 2

In this embodiment, antimony from low-grade complex antimony oxide resources is recovered through the following methods:
(1) Mixing and crushing low-grade oxidized complex antimony ore (including senarmontite, valentinite, kermesite, stibiconite, cervantite, sarabauite, romeite, and a mixture of chemically dissolved antimony) with antimony smelting waste to 50 μm (the addition ratio of antimony smelting waste is 7%) to obtain low-grade complex antimony oxide resources (In low-grade complex oxidic antimony resources, the antimony content is 2.21%, the fluorine content is 1.72%, and the iron content is 8.23%), then mixing the low-grade complex antimony oxide resources with a mixture of bituminous coal and lignite evenly to form pellets (mixture I). The mixing mass ratio of the antimony oxide resources with the mixture of bituminous coal and lignite is 100:5.
(2) Drying the pellets and mixing with a mixture of petroleum coke and coke (ash content: 2%) to form mixture II (the ratio of pellets to bituminous coal is 100:30), then heating the mixture II to 950° C. at a heating rate of 30° C./min by natural gas heating and keeping the temperature for 20 minutes, and then cooling the flue gas to obtain high-quality antimony-containing dust.

The components of roasting slag and flue dust were detected, and the results showed that the antimony content in the roasting slag was only 0.12%, the fluorine-fixing ratio was greater than 98%, and the antimony enrichment rate in the flue dust was greater than 13, which proves that the method can realize high-quality and efficient recovery of antimony resources and reuse of smelting waste.

### Embodiment 3

(1) Crushing low-grade oxidized complex antimony ore (including senarmontite, valentinite, kermesite, stibiconite, cervantite, sarabauite, romeite, and a mixture of chemically dissolved antimony) to 300 μm to obtain low-grade complex antimony oxide resources (In low-grade complex oxidic antimony resources, the antimony content is 5.35%, the fluorine content is 2.14%, and the iron content is 10.71%), then mixing the low-grade complex antimony oxide resources with a mixture of lignite, bituminous coal, and semi coke to form pellets (mixture I). The mixing mass ratio of the low-grade complex antimony oxide resources with the mixture of lignite, bituminous coal, and semi coke is 100:1.
(2) Drying the pellets and mixing with a mixture of bituminous coal, petroleum coke, and coke (ash content: 10%) to form mixture II (the mixing ratio of pellets and bituminous coal is 100:15), then heating the mixture II to 600° C. by natural gas heating at a heating rate of 20° C./min and keeping the temperature for 120 minutes, and then cooling the flue gas to obtain high-quality antimony-containing dust.

The components of roasting slag and flue dust were detected, and the results showed that the antimony content in the roasting slag was only 0.11%, the fluorine-fixing ratio was greater than 97%, and the antimony enrichment rate in the flue dust was greater than 12, which proves that the method can realize high-quality and efficient recovery of antimony resources and reuse of smelting waste.

### Comparative Example 1

The comparative example adopts the same method and raw materials as embodiment 1 to recover antimony from low-grade complex antimony oxide resources. The difference is that in this comparative example, the addition ratio of the antimony oxide resources to the semi coke is 100:15.

The component of roasting slag was detected, and the results showed that the antimony content in the roasting slag was as high as 1.83%.

By comparing embodiment 1 with comparative example 1, it can be seen that excessive carbonaceous reducing agent A can lead to the formation of antimony-iron alloy, severely inhibiting the recovery of antimony.

### Comparative Example 2

The comparative example adopts the same method and raw materials as embodiment 1 to recover antimony from low-grade complex antimony oxide resources. The difference is that in the comparative example, the carbonaceous reducing agent A uses petroleum coke, which has lower carbon dioxide reactivity than anthracite in the temperature range of 600-900° C.

The components of roasting slag and flue dust were detected, and the results showed that the antimony content in the roasting slag was 0.95%, the antimony enrichment rate in the dust was greater than 10, but the fluorine-fixing ratio was only 53%. The fluorine content in flue dust was significantly increased, which was not conducive to application.

By comparing embodiment 1 with comparative example 2, it can be seen that when the performance of carbonaceous reducing agent A does not meet the requirements, it will cause the complex antimony phase to be difficult to selectively convert into Sb(g), and the generated Sb₂O₃(g) will combine with calcium fluoride to generate gases such as Sb₃O₂F₅, which will significantly increase the fluorine content in the flue dust and make it difficult to apply. At the same time, complex antimony phases are difficult to efficiently reduce to antimony gas, resulting in an increase in antimony content in the slag.

### Comparative Example 3

The comparative example adopts the same method and raw materials as in embodiment 1 to recover antimony from low-grade complex antimony oxide resources. The difference is that in the comparative example, carbonaceous reducing agent B uses lignite, which has a 38% ash content.

The components of roasting slag and flue dust were detected, and the results showed that the antimony content in roasting slag was 0.13%, and the fluorine-fixing ratio was greater than 97%, but the antimony enrichment rate in flue dust was only 5.

By comparing embodiment 1 with comparative example 3, it can be seen that excessive ash content of the carbonaceous reducing agent B can lead to an increase in impurities of the flue dust such as alumina and silica, significantly reducing the quality of the flue dust.

### Comparative Example 4

This comparative example adopts the same method and raw materials as in embodiment 2 to recover antimony from low-grade complex antimony oxide resources. The difference is that in the comparative example, the low-grade complex antimony oxide resources are mixed with carbonaceous reducing agent A and carbonaceous reducing agent B by one-step method. The mass ratio of antimony oxide resources, carbonaceous reducing agent A and carbonaceous reducing agent B is 100:5:30

The component of roasting slag was detected, and the results showed that the antimony content in the roasting slag was 0.97%.

By comparing embodiment 2 with comparative example 4, it can be seen that direct mixing of carbonaceous reducing agent A and carbonaceous reducing agent B with low-grade complex antimony oxide resources can lead to the formation of antimony iron alloys and inhibit antimony volatilization.

In summary, the efficient and high-quality recovery of antimony from low-grade complex antimony oxide resources can be realized through a green and low-cost method, solving the “bottleneck” problem in the industry of efficient utilization of low-grade complex antimony oxide resources.

Finally, it should be noted that the above preferred embodiments are only used to illustrate the technical solution of the present disclosure and not to limit it. Although the present disclosure has been described in detail through the above preferred embodiments, those skilled in the art should understand that various changes can be made in form and detail without departing from the scope of the claims of the present disclosure.

What is claimed is:

1. A method for antimony recovery and synergistic fluorine fixation from low-grade complex antimony oxide resources, comprising following steps:
(1) crushing the low-grade complex antimony oxide resources, mixing with carbonaceous reducing agent A uniformly to obtain mixture I, and then making the mixture I into pellets;
(2) drying the pellets obtained in step (1) to obtain dried pellets, mixing the dried pellets with carbonaceous reducing agent B uniformly to obtain mixture II, roasting the mixture II, collecting flue gas generated by roasting, and cooling the flue gas to obtain high-quality antimony-containing dust;
the low-grade complex antimony oxide resources comprise at least one of senarmontite, valentinite, kermesite, stibiconite, cervantite, sarabauite, romeite, and chemically dissolved antimony, mass fraction of antimony in the low-grade complex antimony oxide resource is 1.0-10%;
a carbon dioxide reactivity of the carbonaceous reducing agent A is higher than that of anthracite in the temperature range of 600-900° C.;
an ash mass fraction of the carbonaceous reducing agent B is less than 18%, and a particle size of the carbonaceous reducing agent B is 74 μm-3 cm.

2. The method for antimony recovery and synergistic fluorine fixation from low-grade complex antimony oxide resources according to claim 1, wherein in step (1), a particle size of the low-grade complex antimony oxide resources crushed is 50-300 μm.

3. The method for antimony recovery and synergistic fluorine fixation from low-grade complex antimony oxide resources according to claim 1, wherein the low-grade complex antimony oxide resource further comprises antimony smelting waste, and a mass fraction of the antimony smelting waste in the low-grade complex antimony oxide resource is not more than 15%.

4. The method for antimony recovery and synergistic fluorine fixation from low-grade complex antimony oxide resources according to claim 1, wherein in step (1), a mass ratio of the low-grade complex antimony oxide resources and the carbonaceous reducing agent A is 100:(1-8).

5. The method for antimony recovery and synergistic fluorine fixation from low-grade complex antimony oxide resources according to claim 1, wherein in step (2), a roasting heating rate is 5-30° C./min.

6. The method for antimony recovery and synergistic fluorine fixation from low-grade complex antimony oxide resources according to claim 1, wherein in step (2), a roasting temperature is 600-950° C. and a holding time is 20-220 minutes.

7. The method for antimony recovery and synergistic fluorine fixation from low-grade complex antimony oxide resources according to claim 1, wherein in step (2), a mass ratio of the pellets and the carbonaceous reducing agent B is 100:(5-30).
